(19) United States
(12) Patent Application Publication
(10) Pub. No.: US 2011/0143240 A1
(43) Pub. Date: Jun. 16, 2011

(54) Hydrogen Generation System, Method for Generating Hydrogen Using Solid Hydrogen Fuel and Method for Providing Hydrogen for Fuel Cell Using the Same

(75) Inventors: Chan-Li Hsueh, Qieding Shiang (TW); Jie-Ren Ku, Kaohsiung City (TW); Cheng-Yen Chen, Yongkang City (TW); Ming-Shan Jeng, Xizhi City (TW); Fang-hei Tsau, Kaohsiung City (TW)

(73) Assignee: INDUSTRIAL TECHNOLOGY RESEARCH INSTITUTE, Hsinchu (TW)

(21) Appl. No.: 12/847,643

(22) Filed: Jul. 30, 2010

Related U.S. Application Data
(60) Provisional application No. 61/285,467, filed on Dec. 10, 2009.

(30) Foreign Application Priority Data
Apr. 26, 2010 (TW) 99113137

(51) Int. Cl. H01M 8/06; B01J 8/00; C01B 3/02; C01B 3/08

(52) U.S. Cl. 429/426; 422/187; 423/648.1; 423/657

(57) ABSTRACT

A hydrogen generation system comprising solid hydrogen fuel, a liquid absorbent material, and a phase-change material is provided. When the liquid (usually water, alcohol, or aqueous solution of alcohol, aqueous solution of salt or aqueous solution of acid) in the absorbent material contacts with the solid hydrogen fuel, the solid hydrogen fuel will react with the liquid to release hydrogen and generate heat. The heat as generated will accumulate to increase the reaction temperature, and then boost the hydrogen-releasing rate. The phase-change material is adjacent to the solid hydrogen fuel for absorbing and storing the reaction heat, so as to stabilize the reaction temperature. Therefore, the hydrogen-releasing rate is kept as constant to achieve a steady hydrogen flow.

This application claims the benefits of U.S. provisional application No. 61/285,467, filed Dec. 10, 2009, and Taiwan application Serial No. 099113137, filed Apr. 26, 2010, the subject matters of which are incorporated herein by reference.

### BACKGROUND

1. Technical Field

The disclosure relates in general to a hydrogen generation system, and more particularly to the hydrogen generation system capable of providing hydrogen to a fuel cell at a stabilized hydrogen-releasing rate.

2. Description of the Related Art

Fuel cell is a device capable of converting chemical energy into electrical energy. The fuel cell can generate electrical energy continuously while fuel and oxidant are provided constantly. As to the hydrogen fuel cell, the fuel is hydrogen, and the oxidant is oxygen.

Take a conventional hydrogen production system in a hydrogen fuel cell and sodium borohydride (NaBH₄) solution used as hydrogen source in the hydrogen production system for example. A pump transports sodium borohydride solution (liquid fuel) to a catalyst bed. After hydrogen is released, sodium perborate solution is extracted from the catalyst bed. A hydrogen releasing reaction reacted from sodium borohydride and water is catalyzed by the catalyst bed. The chemical equation (1) is as follows:

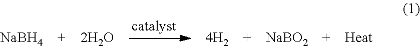

The chemical reaction of equation (1) is accompanied by the release of heat, which is an exothermic reaction. It is not easy to sustain the temperature of the hydrogen generation apparatus at which the hydrogen-releasing reaction occurs at a certain value or range. When the hydrogen-releasing reaction is processing, the accumulated heat increases the temperature of the hydrogen generation apparatus, in turn causing the hydrogen-releasing rate of reaction to be evolved even more quickly. Thus, the hydrogen-releasing rate of the conventional hydrogen generation apparatus would not be stably maintained in a certain value or range. FIG. 1 shows the relationship between the hydrogen-releasing rate and the temperature of the reaction, which is high-positively related.

Moreover, the fuel cells with different powers have different hydrogen consumption rates. The fuel cell could not generate the maximum power if the hydrogen generation system of the fuel cell provides hydrogen gas with the hydrogen-releasing rate under the demand. However, it would be energy waste that the hydrogen-releasing rate of the hydrogen generation system is higher than the standard value required for the fuel cell. Thus, it is an important subject to provide a hydrogen generation system (i.e. hydrogen source) with a stable hydrogen-releasing rate for the fuel cell.

A mechanical design has been disclosed by the people skilled in the art for stabilizing the hydrogen-releasing rate. Taiwan application serial No. 96121493, entitled “Microcartridge Hydrogen Generator”, has disclosed a hydrogen generator, using solid hydride as a hydrogen fuel and a chamber containing a catalyst, for controlling and stabilizing the hydrogen-releasing rate. This hydrogen generator has a very complicated mechanical design with a bulky dimensions and weight, is, which is expansive and not easy to carry for daily use.

Applicant has disclosed a flexible solid hydrogen fuel (Taiwan application serial No. 98108205), using a crushed mixture of a solid hydride and a solid catalyst uniformly dispersing in a polymer matrix. The flexible solid hydrogen fuel could be further deformed into various geometric shapes and put into suitable vessels. Hydrogen can be stably and highly released when water or adequate solution is added into the vessels and reacted with the solid hydrogen fuel. FIG. 2 is a hydrogen-releasing curve of flexible solid hydrogen fuel according to the related art of TW ASN. 98108205. The curve of FIG. 2 is obtained by using a crushed mixture of 3 g of NaBH₄ (solid hydride) and 0.6 g of Co²⁺/IR-120 (solid catalyst) uniformly dispersing in 2.5 g of silicone rubber (polymer matrix).

In addition, Applicant has disclosed a hydrogen supply device (Taiwan application serial No. 98112619) with solid water, for solving the problem of leakage of water or liquid from the hydrogen supply device in use. Water absorbs the heat generated from the hydrogen releasing reaction because of its high specific heat capacity. FIG. 3 is a hydrogen-releasing curve of solid hydrogen fuel and solid water according to the related art of TW ASN. 98112619. The curve of FIG. 3 is obtained by using a crushed mixture of 2 g of NaBH₄ (solid hydride) and 0.4 g of Co²⁺/IR-120 (solid catalyst) uniformly dispersing in 1.6 g of silicone rubber. Solid water is exemplified as gel-forming water. However, solid water such as gel-forming water could not rapidly absorbs the heat generated from the hydrogen releasing reaction, so that the hydrogen releasing rate of the reaction is varied (with the increasing temperature) and could not be sustained at a certain value, as shown in FIG. 3.

### SUMMARY

The disclosure is directed to a hydrogen generation system and a method for generating hydrogen. The hydrogen generation system of the disclosure uses the phase-change material for keeping a temperature of the hydrogen generation system as a constant in a sufficient long time, thereby maintaining a reaction temperature of the hydrogen releasing reaction reacted by the solid hydrogen fuel and the liquid, and consequently stabilizing a hydrogen releasing rate of the hydrogen releasing reaction.

According to a first aspect of the present disclosure, a hydrogen generation system is provided, comprising a solid hydrogen fuel, an absorbent material and a phase-change material. The absorbent material absorbs a liquid in the system. Examples of the liquid include water, alcohols and aqueous solutions thereof, aqueous solutions of salts, aqueous solutions of acids, and a mixture thereof. The phase-change material is disposed adjacent to a position at which a hydrogen releasing reaction occurs, for absorbing and storing the reaction heat generated from the hydrogen releasing reaction reacted by the solid hydrogen fuel and the liquid, thereby maintaining the reaction temperature. Consequently, the hydrogen releasing rate of the hydrogen releasing reaction can be controlled, and a hydrogen flow can be stabilized.

According to a second aspect of the present disclosure, a method for generating hydrogen using solid hydrogen fuel is provided, comprising steps of:

providing a solid hydrogen fuel, at least comprising a solid hydride powder and a solid hydrogen releasing catalyst;

providing an absorbent material, mixed with the solid hydrogen fuel in a fuel pack;

providing a liquid pack comprising a liquid of water, alcohols and aqueous solutions thereof, aqueous solutions of salts, aqueous solutions of acids, or a combination thereof.

providing a phase-change material, disposed adjacent to the solid hydrogen fuel; and

conducting water or aqueous solution of the liquid pack into the fuel pack for bringing about a hydrogen releasing reaction; wherein the absorbent material is capable of absorbing the liquid of water, alcohols and aqueous solutions thereof, aqueous solutions of salts, aqueous solutions of acids, or the combination thereof, and the phase-change material is used for stabilizing a temperature of the hydrogen releasing reaction reacted by the solid hydrogen fuel and the liquid.

According to a third aspect of the present disclosure, a method for applying solid hydrogen fuel to fuel cell is provided, comprising steps of:

providing a solid hydrogen fuel as disclosed in the second aspect;

providing an absorbent material, mixed with the solid hydrogen fuel in a fuel pack;

providing a liquid pack comprising a liquid of water, alcohols and aqueous solutions thereof, aqueous solutions of salts, aqueous solutions of acids, or a combination thereof;

providing a phase-change material, disposed adjacent to the solid hydrogen fuel;

conducting water or aqueous solution of the liquid pack into the fuel pack for bringing about a hydrogen releasing reaction; and

providing a fuel cell applied with the hydrogen released from the solid hydrogen fuel; wherein the absorbent material is capable of absorbing the liquid of water, alcohols and aqueous solutions thereof, aqueous solutions of salts, aqueous solutions of acids, or the combination thereof, and the phase-change material is used for stabilizing a temperature of the hydrogen releasing reaction reacted by the solid hydrogen fuel and the liquid.

The above and other aspects of the disclosure will become better understood with regard to the following detailed description of the non-limiting embodiment(s). The following description is made with reference to the accompanying drawings.

### BRIEF DESCRIPTION OF THE DRAWINGS

FIG. 1 shows the relationship between the hydrogen-releasing rate and the temperature of the reaction, which is high-positively related.

FIG. 2 is a hydrogen-releasing curve of flexible solid hydrogen fuel according to the related art of TW ASN. 98108205.

FIG. 3 is a hydrogen-releasing curve of solid hydrogen fuel and solid water according to the related art of TW ASN. 98112619.

FIG. 4 illustrates a method for generating hydrogen using solid hydrogen fuel of hydrogen production system according to the first embodiment of the present disclosure.

FIG. 5 illustrates a hydrogen production system with the solid hydrogen fuel according to the second embodiment of the present disclosure.

FIG. 6 illustrates a fuel cell using hydrogen from the hydrogen production system of the second embodiment of the present disclosure.

FIG. 7A shows the hydrogen releasing curves of the solid hydrogen fuel, using Na₂SO₄. 10H₂O as the phase-change material, according to the embodiment of the present disclosure.

FIG. 7B shows the enlarged hydrogen releasing curves (c) and (d) of FIG. 7A.

FIG. 8 shows the hydrogen releasing curves of the solid hydrogen fuel, using Na₂HPO₄. 12H₂O as the phase-change material, according to the embodiment of the present disclosure.

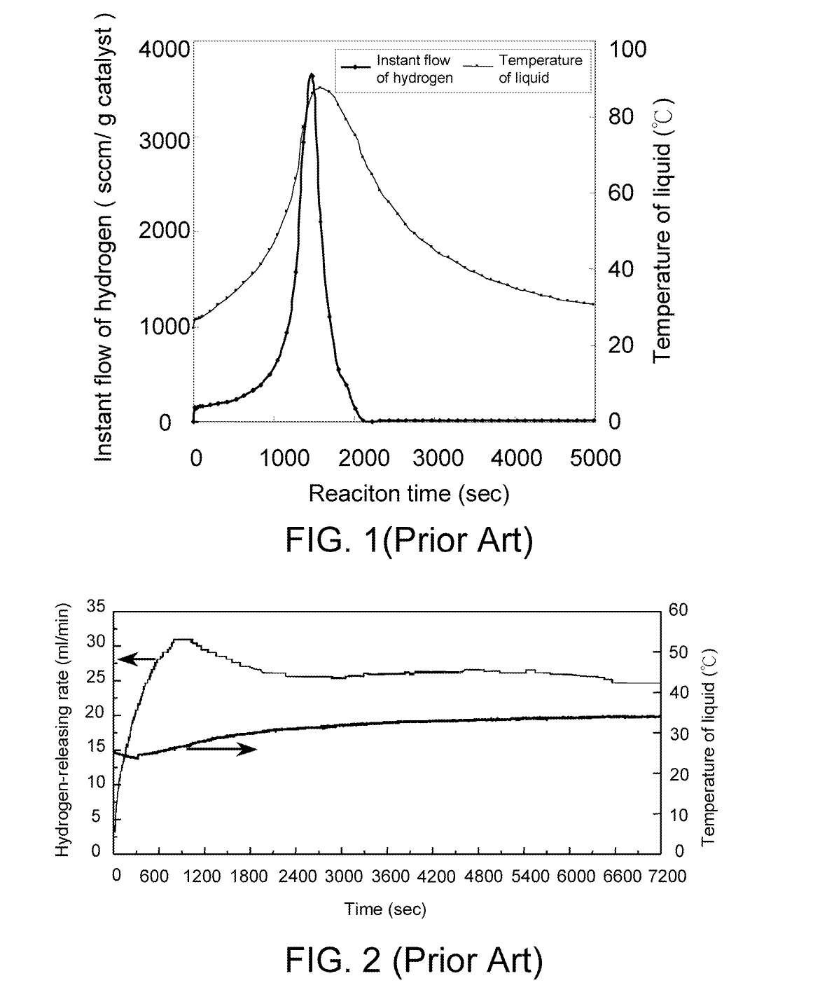

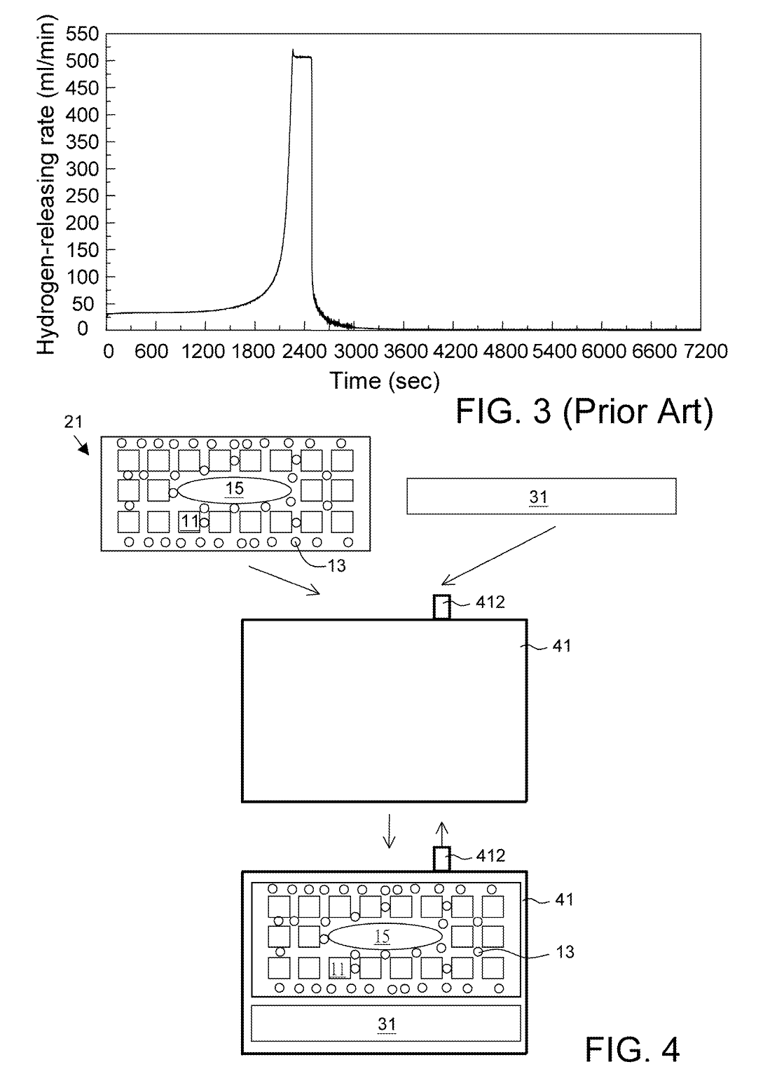

### DETAILED DESCRIPTION

A hydrogen generation system, a method for generating hydrogen using solid hydrogen fuel and a method for providing hydrogen for a fuel cell using the solid hydrogen fuel are provided in the present disclosure. The phase-change material is used for keeping a temperature of the hydrogen generation system as a constant in a sufficient long time, thereby maintaining a reaction temperature of the hydrogen releasing reaction reacted by the solid hydrogen fuel and the liquid, and consequently stabilizing a hydrogen releasing rate of the hydrogen releasing reaction.

The embodiments are provided to demonstrate the hydrogen generation system, the method for generating hydrogen using solid hydrogen fuel and the method for providing hydrogen for a fuel cell using the solid hydrogen fuel. Also, the embodiments are described with reference to the related experiments. However, the compounds, materials and steps for providing hydrogen illustrated in the embodiments are not intended to limit the invention. The modifications and variations can be made without departing from the spirit of the invention to meet the requirements of the practical applications.

### First Embodiment

In an embodiment, a hydrogen generation system, capable of generating hydrogen for a fuel cell, comprises a solid hydrogen fuel, an absorbent material, a phase-change material and a liquid such as water, alcohols (ex: methanol or ethanol) or aqueous solutions thereof. The absorbent material is mixed with the solid hydrogen fuel and absorbs the liquid such as water, alcohols and aqueous solutions thereof, aqueous solutions of salts, or aqueous solutions of acids. The phase-change material is disposed adjacent to a position at which a hydrogen releasing reaction occurs. The phase-change material absorbs and stores the reaction heat generated from the hydrogen releasing reaction reacted by the solid hydrogen fuel and the liquid, so as to maintain a reaction temperature. Consequently, a hydrogen releasing rate of the hydrogen releasing reaction is controlled and a hydrogen flow is stabilized.

In the first embodiment, the phase-change material, the solid hydrogen fuel and the absorbent material are disposed in the same pack.

FIG. 4 illustrates a method for generating hydrogen using solid hydrogen fuel of hydrogen production system according to the first embodiment of the present disclosure. First, a solid hydrogen fuel 11, an absorbent material 13 and a phase-change material 15 are provided. A fuel pack 21 is formed by mixing the solid hydrogen fuel 11 and the absorbent material 13 with addition of the phase-change material 15. Then, a liquid package 31 containing liquid, such as water, alcohols and aqueous solutions thereof, aqueous solutions of salts, or aqueous solutions of acids, is provided. Afterward, the fuel pack 21 and the liquid package 31 are disposed into a hydrogen releasing apparatus 41. When water or aqueous solution of the liquid package 31 is conducted into the fuel pack, a hydrogen releasing reaction occurs, and hydrogen generated from the solid hydrogen fuel 11 could be discharged from the gas outlet 412 for providing the power of a fuel cell. The absorbent material 13 is capable of absorbing water or aqueous solution, and the phase-change material 15 is used for stabilizing a temperature of the hydrogen releasing reaction reacted by the solid hydrogen fuel 11 and the liquid, so as to maintain a hydrogen releasing rate at a certain range in a sufficiently long time.

In an embodiment, the solid hydrogen fuel at least comprises a solid hydride powder and a solid hydrogen releasing catalyst. The solid hydride powder reacts with the liquid, such as water, alcohols and aqueous solutions thereof, aqueous solutions of salts, aqueous solutions of acids, or a mixture thereof, to bring about the hydrogen releasing reaction. The solid hydrogen releasing catalyst catalyzes the hydrogen releasing reaction for producing hydrogen. In another embodiment, the solid hydrogen fuel further comprises a flexible polymer matrix as a molding agent, for providing flexibility of the solid hydrogen fuel.

In an embodiment, solid hydride powder could be boron hydride, nitrogen hydride, carbon hydride, metal hydride, nitrogen borohydride, carbon borohydride, nitrogen carbon hydride, metal borohydride, metal nitrogen hydride, metal carbon hydride, metal nitrogen borohydride, metal carbon borohydride, metal nitrogen carbon hydride, nitrogen carbon borohydride, metal nitrogen carbon borohydride, or a combination thereof. Examples of the solid hydride powder include sodium borohydride (NaBH₄), lithium aluminum hydride (LiAlH₄), sodium aluminum hydride (NaAlH4), magnesium aluminum hydride (Mg(AlH₄)₂), calcium aluminum hydride (Ca(AlH₄)₂), lithium borohydride (LiBH₄), potassium borohydride (KBH₄), beryllium borohydride (Be(BH₄)₂), magnesium borohydride (Mg(BH₄)₂), calcium borohydride (Ca(BH₄)₂), lithium hydride (LiH), sodium hydride (NaH), magnesium hydride (MgH₂), or calcium hydride (CaH₂).

In another embodiment, the solid hydride powder is a hydride or a chemical compound represented by the formula BxNyHz. Examples of compound represented by the formula BxNyHz include ammonia borane (H3BNH3), diborane, H2B(NH3)2BH4, poly(amine-borane), borazine (B3N3H6), borane-tetrahydrofuran complex, and diborane and the likes.

Moreover, the solid hydrogen releasing catalyst may comprises solid acid, or metal salt including at least one of ruthenium, cobalt, nickel, copper and iron, or metal nano-particles/micro-particles including at least one of ruthenium, cobalt, nickel, copper and iron, or a plurality of catalyst metal carriers covered by metal irons/metal atomics/metal nano-particles/meta micro-particles including at least one of ruthenium, cobalt, nickel, copper and iron.

In the embodiment, the absorbent material comprises an absorbing cotton and at least an absorbent polymer. Examples of the absorbing cotton include tissues, absorbent cotton fabric, cosmetic cottons and any cotton products. Examples of the absorbent polymer include at least one or more of polyacrylate, poly(vinyl alcohol), vinyl acetate copolymer, poly urethane, poly(ethylene oxide), and starch graft copolymer/rubber blend.

In the embodiment, the solid hydrogen fuel comprises a flexible polymer matrix having a hydrophobic polymer elastomer such as silicone, rubber, and silicon rubber, for providing a flexibility and deformation of the solid hydrogen fuel.

It is noted that the compounds of the solid hydride powder, the solid hydrogen releasing catalyst and the flexible polymer matrix of the solid hydrogen fuel are not limited to the any specific aforementioned compounds. Also, the solid hydride powder, the solid hydrogen releasing catalyst and the flexible polymer matrix could be the ground or un-ground powders, dispersed or pressed as the tablets, depending on the requirements of the practical application.

In the embodiment, the phase-change material could be the compound selected from the groups of inorganic or organic phase-change materials, phase-change materials of eutectic system or solid-liquid system. Examples of the organic phase-change materials include any or more materials of aliphatic compounds, polyhydric alcohols and paraffin waxes. Examples of the inorganic phase-change materials include acids and hydrated slats (ex: with melting points ranged from 15˜120).

Table 1˜Table 4 respectively list various compounds selected from the inorganic phase-change materials, the organic phase-change materials, the phase-change materials of eutectic system and the phase-change materials of solid-liquid system, and the melting points and the latent heats thereof. The suitable phase-change material could be selected from the compounds listed in Table 1˜Table 4 according to relationship, and the practical requirements of the application (ex: the hydrogen releasing rate of the solid hydrogen fuel required to be sustained in a certain range), with reference to the relationship between the temperature and the hydrogen releasing rate of the hydrogen releasing reaction.

### Second Embodiment

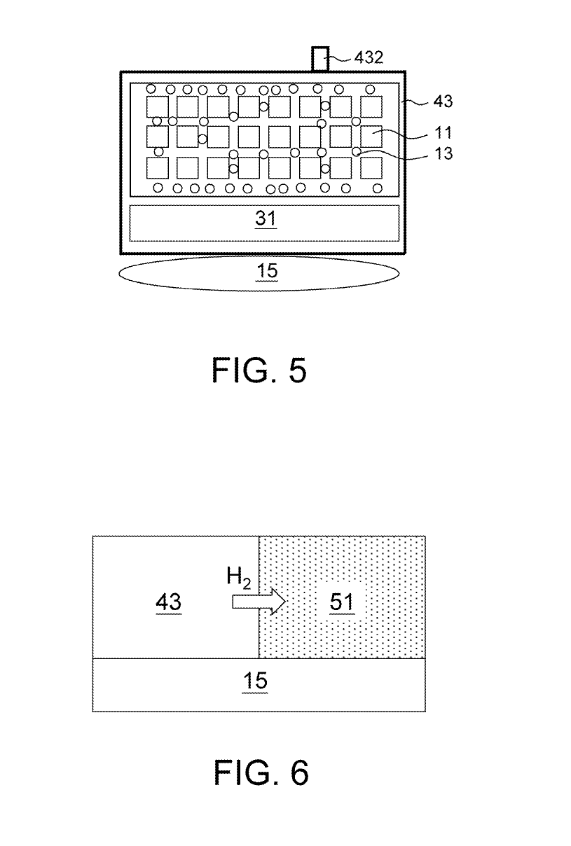

FIG. 5 illustrates a hydrogen production system with the solid hydrogen fuel according to the second embodiment of the present disclosure. The system composition of the second embodiment is identical to that of the first embodiment. The hydrogen releasing apparatus 43 of FIG. 5 has a fuel pack and a liquid package 31. However, only a mixture of the solid hydrogen fuel 11 and the absorbent material 13 is disposed in the fuel pack. The phase-change material 15 is disposed outside the fuel pack and directly contacts a container at which the fuel pack is placed (i.e. the hydrogen releasing apparatus 43). The phase-change material 15 is used for absorbing and storing the reaction heat generated from the hydrogen releasing reaction via heat conduction. Please also refer to the descriptions in the first embodiment for the compounds of the solid hydrogen fuel and the process for hydrogen releasing reaction in details.

Similarly, the hydrogen production system of the second embodiment achieves the object of maintaining a reaction temperature of the hydrogen releasing reaction and consequently stabilizing a hydrogen releasing rate thereof using the phase-change material. In the second embodiment, the phase-change material 15 disposed outside the fuel pack is reusable. Practically, the hydrogen production system of the second embodiment is good for environmental conservation and also cost saving.

FIG. 6 illustrates a fuel cell using hydrogen from the hydrogen production system of the second embodiment of the present disclosure. As shown in FIG. 6, the hydrogen releasing apparatus 43 (FIG. 5) incorporating with the phase-change material 15 would stably and continuously provide hydrogen to the fuel cell 51 in an sufficient long time. The temperature of the fuel cell 51 is kept at a certain range since the phase-change material 15 absorbing and storing the reaction heat generated from the hydrogen releasing reaction. It is very convenient for the user that the phase-change material 15 and/or the fuel pack of the hydrogen releasing apparatus 43 are/is replaceable after the fuel cell used for a (long) while.

Several experiments are conducted in the embodiments of the present disclosure for observing the effects of the phase-change material on the hydrogen releasing rate. Two experiments and the results thereof are disclosed below.

### Relative Experiment 1

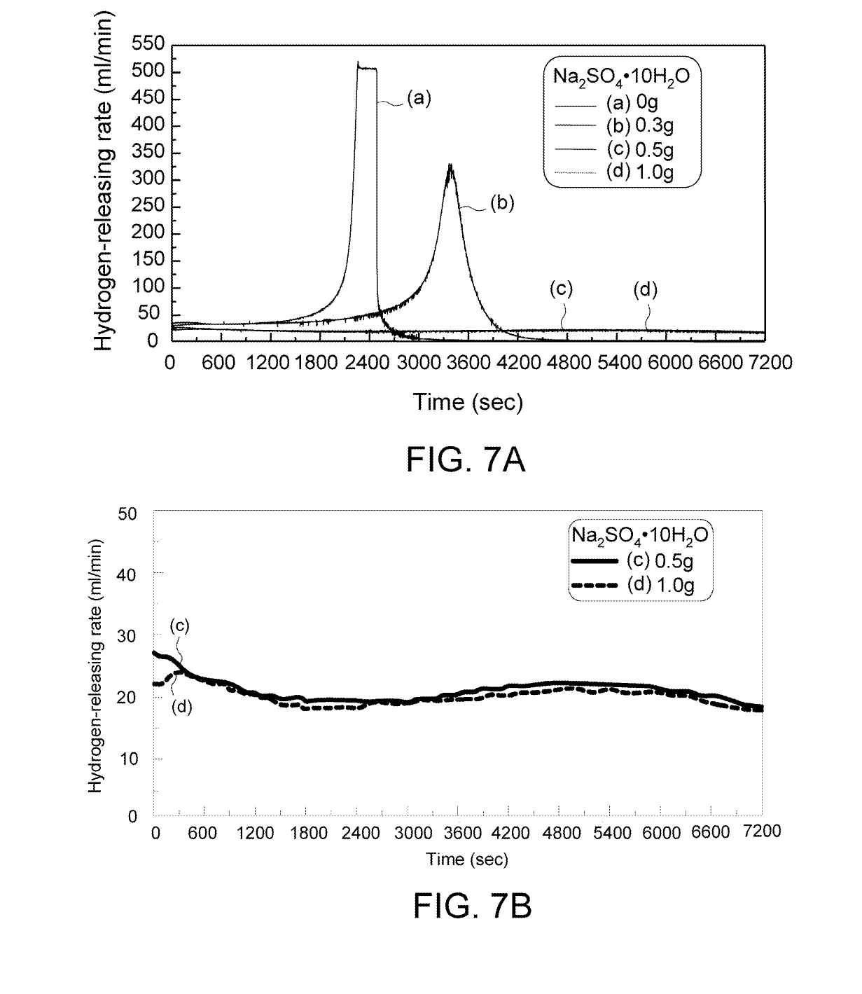

Please also referred to FIG. 4. 4 g of the flexble solid hydrogen fuel, comprising 2 g of NaBH₄ (solid hydrogen powder), 0.4 g of cobalt ion catalyst (Co²⁺/IR-120, solid hydrogen releasing catalyst) and 1.6 g of silicone subber (i.e. molding agent), is divided into 96 pieces and blended with the absorbing polymer (absorbent material); then, the phase-change material Na₂SO₄. 10H₂O is added into this mixture for manufacturing a fuel pack. A liquid package is provided by adding water into a plastic bag with enclosure. The fuel pack and the liquid package are disposed into a hydrogen releasing apparatus. Afterwards, water in the liquid package is conducted into the fuel pack by piercing the plastic bag, and the hydrogen releasing rate is measured. FIG. 7A shows the hydrogen releasing curves of the solid hydrogen fuel, using Na₂SO₄.10H₂O as the phase-change material, according to the embodiment of the present disclosure. FIG. 7B shows the enlarged hydrogen releasing curves (c) and (d) of FIG. 7A.

As shown in FIG. 7A and FIG. 7B, curves (a)˜(d) represent the hydrogen releasing curves of the solid hydrogen fuel with addition of 0 g, 0.3 g, 0.5 g and 1.0 g of the phase-change materials, respectively. The results have indicated that the hydrogen-releasing rate quickly reaches the maximum values in the absence of the phase-change material, and hydrogen is completely released in a short time. Addition of 0.3 g of the phase-change material has the effect on the hydrogen-releasing rate and sustaining time. The results have indicated that the hydrogen releasing rate and sustaining time have been greatly improved while 0.5 g of the phase-change material has been added. Also, the results of FIG. 7B have indicated that additions of 0.5 g and 1.0 g of the phase-change materials have very similar effects on the hydrogen-releasing rate and sustaining time. Accordingly, when a certain ratio of the phase-change material has been added, the temperature of the reaction system could be controlled and a hydrogen releasing rate could be maintained at a certain range in a sufficiently long time.

### Relative Experiment 2

The procedures of the relative experiments 1 and 2 are similar, except the uses of Na₂SO₄.10H₂O as the phase-change material in the relative experiment 2.

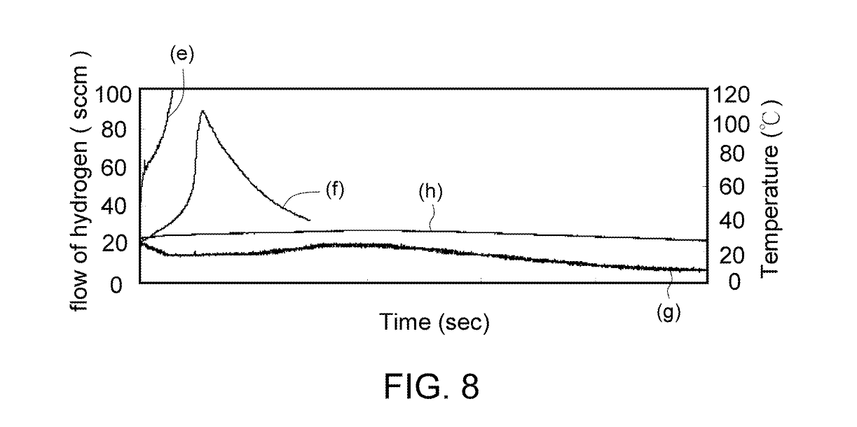

First, 2.5 g of the flexble solid hydrogen fuel (from the composition of 10 g of NaBH₄ (solid hydrogen powder), 3 g of cobalt ion catalyst (Co²⁻/IR-120, solid hydrogen releasing catalyst) and 6 g of clay (i.e. molding agent) is divided into 96 pieces and blended with 1 g of sodium polyacrylate (the absorbent material); then, the phase-change material Na₂HPO₄.12H₂O is added into this mixture for manufacturing a fuel pack. A liquid package is provided by adding water into a plastic bag with enclosure. The fuel pack and the liquid package are disposed into a hydrogen releasing apparatus. Afterwards, water in the liquid package is conducted into the fuel pack by piercing the plastic bag, and the hydrogen releasing rate is measured. FIG. 8 shows the hydrogen releasing curves of the solid hydrogen fuel, using Na₂HPO₄.12H₂O as the phase-change material, according to the embodiment of the present disclosure.

As shown in FIG. 8, curves (e) and (f) respectively represent the hydrogen releasing curve of the solid hydrogen fuel and the temperature curve of hydrogen releasing reaction without addition of the phase-change materials. Also, curves (g) and (h) respectively represent the hydrogen releasing curve of the solid hydrogen fuel and the temperature curve of hydrogen releasing reaction in the addition of 2 g of the phase-change materials. The results of FIG. 8 have indicated that using Na₂HPO₄.12H₂O as the phase-change material has similar effect on the stabilization of the hydrogen releasing rate as well.

According to the aforementioned description, the hydrogen generation system, a method for generating hydrogen using solid hydrogen fuel and a method for providing hydrogen for a fuel cell using the solid hydrogen fuel, as presented in the present disclosure, use the phase-change material for keeping a temperature of the hydrogen generation system as a constant in a sufficient long time, thereby maintaining a reaction temperature of the hydrogen releasing reaction (reacted by the solid hydrogen fuel and the liquid), and consequently stabilizing a hydrogen releasing rate of the hydrogen releasing reaction. Compared to conventional ways for generating hydrogen with complicated and bulky mechanical structure, the hydrogen production system of the disclosure is much smaller and easier to be carried. The required space of the hydrogen production system of the disclosure is reduced effectively, and the weight of the product is lowered. Moreover, electricity of the applied product can be generated from the hydrogen-releasing reaction by just contacting the solid hydrogen fuel with water. Thus, the hydrogen production system using solid hydrogen fuel and methods for generating hydrogen and providing hydrogen for fuel cell according to the embodiments have several advantages. It is easier to match the mechanical design of the system and product, which simplifies the design of hydrogen production system. Furthermore, solid hydrogen fuel releases hydrogen stably in a sufficiently long time. Above advantages increase users' willingness to use the product and widen the application field of the product.

While the disclosure has been described by way of example and in terms of the exemplary embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

TABLE 1
Inorganic Phase-Change Materials

| | Chemical | Melting | Latent | |
|---|---|---|---|---|
| Material | Formula | point ( ) | Heat (kJ/kg) | Notes |
| Acids | | | | |
| Acetic acid | CH₃COOH | 16.7 | 184 | |
| Polyethylene | H(OC₂H₂)n_OH | 20-25 | 146 | |
| glycol 600 | | | | |
| Capric acid | CH₃(CH₂)₈_{_{—}}COOH | 36 | 152 | |
| Eladic acid | C₈H₇C₉H₁₆_{_{—}}COOH | 47 | 218 | |
| Lauric acid | CH₃(CH₂)₁₀_{_{—}}COOH | 49 | 178 | |
| Pentadecanoic | CH₃(CH₂)₁₃_{_{—}}COOH | 52.5 | 178 | |
| acid | | | | |
| Tristearin | (C₁₇H₃₅COO)C₃H₅ | 56 | 191 | |
| Myristic acid | CH₃(CH₂)₁₂_{_{—}}COOH | 58 | 199 | |
| Palmatic acid | CH₃(CH₂)₁₄_{_{—}}COOH | 55 | 163 | |
| Stearic acid | CH₃(CH₂)₁₆_{_{—}}COOH | 69.4 | 199 | |
| Acetamide | CH₃CONH₂ | 81 | 241 | |
| Methyl | (CHCO₂NH₃)₂ | 102 | 242 | |
| furmarate | | | | |
| Salts | | | | |
| | K₂HPO₄_{_{—}}6H₂O | 14.0 | 109 | |
| | FeBr₃_{_{—}}6H₂O | 21.0 | 105 | |
| | Mn(NO₃)₂_{_{—}}6H₂O | 25.5 | 148 | |
| | FeBr₃_{_{—}}6H₂O | 27.0 | 105 | |
| | CaCl₂_{_{—}}12H₂O | 29.8 | 174 | |
| | LiNO₃_{_{—}}2H₂O | 30.0 | 296 | |
| | LiNO₃_{_{—}}3H₂O | 30 | 189 | |
| | Na₂CO₃_{_{—}}10H₂O | 32.0 | 267 | |
| | Na₂SO₄_{_{—}}10H₂O | 32.4 | 241 | |
| | KFe(SO₄)₂_{_{—}}12H₂O | 33 | 173 | |
| | CaBr₂_{_{—}}6H₂O | 34 | 138 | |
| | LiBr₂_{_{—}}2H₂O | 34 | 124 | |
| | Zn(NO₃)₂_{_{—}}6H₂O | 36.1 | 134 | |
| | FeCl₃_{_{—}}6H₂O | 37.0 | 223 | |
| | Mn(NO₃)₂_{_{—}}4H₂O | 37.1 | 115 | |
| | Na₂HPO₄_{_{—}}12H₂O | 40.0 | 279 | |
| | CoSO₄_{_{—}}7H₂O | 40.7 | 170 | |
| | KF_2H₂O | 42 | 162 | |
| | MgI₂_{_{—}}8H₂O | 42 | 133 | |
| | CaI₂_{_{—}}6H₂O | 42 | 162 | |
| | K₂HPO₄_{_{—}}7H₂O | 45.0 | 145 | |
| | Zn(NO₃)₂_{_{—}}4H₂O | 45 | 110 | |
| | Mg(NO₃)_4H₂O | 47.0 | 142 | |
| | Ca(NO₃)_4H₂O | 47.0 | 153 | |
| | Fe(NO₃)₃_{_{—}}9H₂O | 47 | 155 | |
| | Na₂SiO₃_{_{—}}4H₂O | 48 | 168 | |
| | K₂HPO₄_{_{—}}3H₂O | 48 | 99 | |
| | Na₂S₂O₃_{_{—}}5H₂O | 48.5 | 210 | |
| | MgSO₄_{_{—}}7H₂O | 48.5 | 202 | |
| | Ca(NO₃)₂_{_{—}}3H₂O | 51 | 104 | |
| | Zn(NO₃)₂_{_{—}}2H₂O | 55 | 68 | |
| | FeCl₃_{_{—}}2H₂O | 56 | 90 | |
| | Ni(NO₃)₂_{_{—}}6H₂O | 57.0 | 169 | |
| | MnCl₂_{_{—}}4H₂O | 58.0 | 151 | |
| | MgCl₂_{_{—}}4H₂O | 58.0 | 178 | |
| | CH₃COONa_3H₂O | 58.0 | 265 | |
| | Fe(NO₃)₂_{_{—}}6H₂O | 60.5 | 126 | |
| | NaAl(SO₄)₂_{_{—}}10H₂O | 61.0 | 181 | |
| | NaOH_H₂O | 64.3 | 273 | |
| | Na₃PO₄_{_{—}}12H₂O | 65.0 | 190 | |
| | LiCH₃COO_2H₂O | 70 | 150 | |
| | Al(NO₃)₂_{_{—}}9H₂O | 72 | 155 | |
| | Ba(OH)₂_{_{—}}8H₂O | 78 | 265 | |
| | Mg(NO₃)₂_{_{—}}6H₂O | 89.9 | 167 | |
| | KAl (SO₄)₂_{_{—}}12H₂O | 91 | 184 | |
| | MgCl₂_{_{—}}6H₂O | 117 | 167 | |

TABLE 2
Organic Phase-Change Materials

| Material | Composition/ | solidification | Latent | |
|---|---|---|---|---|
| Paraffin waxs | Product | point ( ) | Heat (kJ/kg) | Notes |
| | No. 6106 | 42-44 | 189 | Ter Hell |
| | | | | Paraffin |
| | | | | Hamburg, |
| | | | | FRG |
| | No. 5838 | 48-50 | 189 | Ter Hell |
| | | | | Paraffin |
| | | | | Hamburg, |
| | | | | FRG |
| | No. 6035 | 58-60 | 189 | Ter Hell |
| | | | | Paraffin |
| | | | | Hamburg, |
| | | | | FRG |
| | No. 6403 | 62-64 | 189 | Ter Hell |
| | | | | Paraffin |
| | | | | Hamburg, |
| | | | | FRG |
| | No. 6499 | 66-68 | 189 | Ter Hell |
| | | | | Paraffin |
| | | | | Hamburg, |
| | | | | FRG |
| | No. P116 | 45-48 | 210 | Sun |
| | | | | Company, |
| | | | | USA |

| Paraffin | Carbon | Melting | Latent | |
|---|---|---|---|---|
| Waxs | Number | Point ( ) | Heat (kJ/kg) | Notes |
| | 14 | 5.5 | 228 | |
| | 15 | 10 | 205 | |
| | 16 | 16.7 | 237.1 | |
| | 17 | 21.7 | 213 | |
| | 18 | 28.0 | 244 | |
| | 19 | 32.0 | 222 | |
| | 20 | 36.7 | 246 | |
| | 21 | 40.2 | 200 | |
| | 22 | 44.0 | 249 | |
| | 23 | 47.5 | 232 | |
| | 24 | 50.6 | 255 | |
| | 25 | 49.4 | 238 | |
| | 26 | 56.3 | 256 | |
| | 27 | 58.8 | 236 | |
| | 28 | 61.6 | 253 | |
| | 29 | 63.4 | 240 | |
| | 30 | 65.4 | 251 | |
| | 31 | 68.0 | 242 | |
| | 32 | 69.5 | 170 | |
| | 33 | 73.9 | 268 | |
| | 34 | 75.9 | 269 | |

| Non-Paraffin | | Melting | Latent | |
|---|---|---|---|---|
| waxs | Material | point ( ) | Heat (kJ/kg) | Notes |
| | Formic acid | 7.8 | 247 | |
| | Caprilic acid | 16.3 | 149 | |
| | Glycerin | 17.9 | 198.7 | |
| | D-Lattic acid | 26 | 184 | |
| | Methyl palmitate | 29 | 205 | |
| | Camphenilone | 39 | 205 | |
| | Docasyl bromide | 40 | 201 | |
| | Caprylone | 40 | 259 | |
| | Phenol | 41 | 120 | |
| | Heptadecanone | 41 | 201 | |
| | 1-Cyclo- | 41 | 218 | |
| | hexylooctadecane | | | |
| | 4-Heptadacanone | 41 | 197 | |
| | p-Joluidine | 43.3 | 167 | |
| | Cyanamide | 44 | 209 | |
| | Methyl eicosanate | 45 | 230 | |
| | 3-Heptadecanone | 48 | 218 | |
| | 2-Heptadecanone | 48 | 218 | |
| | Hydrocinnamic acid | 48.0 | 118 | |
| | Cetyl alcohol | 49.3 | 141 | |
| | a-Nepthylamine | 50.0 | 93 | |
| | Camphene | 50 | 238 | |
| | O-Nitroaniline | 50.0 | 93 | |
| | 9-Heptadecanone | 51 | 213 | |
| | Thymol | 51.5 | 115 | |
| | Methyl behenate | 52 | 234 | |
| | Diphenyl amine | 52.9 | 107 | |
| | p-Dichlorobenzene | 53.1 | 121 | |
| | Oxolate | 54.3 | 178 | |
| | Hypophosphoric acid | 55 | 213 | |
| | O-Xylene dichloride | 55.0 | 121 | |
| | b-Chloroacetic acid | 56.0 | 147 | |
| | Chloroacetic acid | 56 | 130 | |
| | Nitro naphthalene | 56.7 | 103 | |
| | Trimyristin | 33-57 | 201-213 | |
| | Heptaudecanoic acid | 60.6 | 189 | |
| | a-Chloroacetic acid | 61.2 | 130 | |
| | Bee wax | 61.8 | 177 | |
| | Bees wax | 61.8 | 177 | |
| | Glyolic acid | 63.0 | 109 | |
| | Glycolic acid | 63 | 109 | |
| | p-Bromophenol | 63.5 | 86 | |
| | Azobenzene | 67.1 | 121 | |
| | Acrylic acid | 68.0 | 115 | |
| | Dinto toluent (2,4) | 70.0 | 111 | |
| | Phenylacetic acid | 76.7 | 102 | |
| | Thiosinamine | 77.0 | 140 | |
| | Bromcamphor | 77 | 174 | |
| | Durene | 79.3 | 156 | |
| | Benzylamine | 78.0 | 174 | |
| | Methyl brombrenzoate | 81 | 126 | |
| | Alpha napthol | 96 | 163 | |
| | Glautaric acid | 97.5 | 156 | |
| | p-Xylene dichloride | 100 | 138.7 | |
| | Catechol | 104.3 | 207 | |
| | Quinone | 115 | 171 | |
| | Acetanilide | 118.9 | 222 | |
| | Succinic anhydride | 119 | 204 | |
| | Benzoic acid | 121.7 | 142.8 | |
| | Stibene | 124 | 167 | |
| | Benzamide | 127.2 | 169.4 | |

TABLE 3
Phase-Change Materials of Eutectic System

| Metal | | Melting | Latent | |
|---|---|---|---|---|
| Eutectic | Material | point ( ) | heat (kJ/kg) | Notes |
| | Gallium-gallium | 29.8 | — | |
| | antimony | | | |
| | eutectic | | | |
| | Gallium | 30.0 | 80.3 | |
| | Cerrolow | 58 | 90.9 | |
| | eutectic | | | |
| | Bi—Cd—In eutectic | 61 | 25 | |
| | Cerrobend eutectic | 70 | 32.6 | |
| | Bi—Pb—In eutectic | 70 | 29 | |
| | Bi—In eutectic | 72 | 25 | |
| | Bi—Pb-tin | 96 | — | |
| | eutectic | | | |
| | Bi—Pb eutectic | 125 | — | |

| | | Melting | Latent | |
|---|---|---|---|---|
| Organic-Inorganic | Compositions | point | heat | |
| Eutectic | (wt. %) | ( ) | (kJ/kg) | Notes |
| CaCl₂_{_{—}}6H₂O + | 45 + 55 | 14.7 | 140 | |
| CaBr₂_{_{—}}6H₂O | | | | |
| Triethylolethane + | 38.5 + 31.5 + 30 | 13.4 | 160 | |
| water + urea | | | | |
| C₁₄H₂₈O₂ + | 34 + 66 | 24 | 147.7 | |
| C₁₀H₂₀O₂ | | | | |
| CaCl₂ + | 50 + 50 | 25 | 95 | |
| MgCl₂_{_{—}}6H₂O | | | | |
| CH₃CONH₂ + | 50 + 50 | 27 | 163 | |
| NH₂CONH₂ | | | | |
| Triethylolethane + | 62.5 + 37.5 | 29.8 | 218 | |
| urea | | | | |
| Ca(NO₃)_4H₂O + | 47 + 53 | 30 | 136 | |
| Mg(NO₃)₃_{_{—}}6H₂O | | | | |
| CH₃COONa_3H₂O + | 40 + 60 | 30 | 200.5 | |
| NH₂CONH₂ | | | | |
| NH₂CONH₂ + | 53 + 47 | 46 | 95 | |
| NH₄NO₃ | | | | |
| Mg(NO₃)₃_{_{—}}6H₂O + | 61.5 + 38.5 | 52 | 125.5 | |
| NH₄NO₃ | | | | |
| Mg(NO₃)₃_{_{—}}6H₂O + | 58.7 + 41.3 | 59 | 132.2 | |
| MgCl₂_{_{—}}6H₂O | | | | |
| Mg(NO₃)₃_{_{—}}6H₂O + | 50 + 50 | 59.1 | 144 | |
| MgCl₂_{_{—}}6H₂O | | | | |
| Mg(NO₃)₃_{_{—}}6H₂O + | 53 + 47 | 61 | 148 | |
| Al(NO₃)₂_{_{—}}9H₂O | | | | |
| CH₃CONH₂ + | 50 + 50 | 65 | 218 | |
| C₁₇H₃₅COOH | | | | |
| Mg(NO₃)₂_{_{—}}6H₂O + | 59 + 41 | 66 | 168 | |
| MgBr₂_{_{—}}6H₂O | | | | |
| Napthalene + | 67.1 + 32.9 | 67 | 123.4 | |
| benzoic acid | | | | |
| NH₂CONH₂ + | 66.6 + 33.4 | 76 | 151 | |
| NH₄Br | | | | |
| LiNO₃ + NH₄NO₃ + | 25 + 65 + 10 | 80.5 | 113 | |
| NaNO₃ | | | | |
| LiNO₃ + NH₄NO₃ + | 26.4 + 58.7 + 14.9 | 81.5 | 116 | |
| KNO₃ | | | | |
| LiNO₃ + NH₄NO₃ + | 27 + 68 + 5 | 81.6 | 108 | |
| NH₄Cl | | | | |

TABLE 4
Phase-Change Material of Solid-Liquid System

| | | | Latent | Specific Heat |
|---|---|---|---|---|
| | Liquid | Temperature | Heat | Capacity |
| Material | Phase | Range ( ) | (kJ/kg) | (J/kg · K) |
| Rock | | 20 | 2560 | 879 |
| Brick | | 20 | 1600 | 840 |
| Concrete | | 20 | 1900-2300 | 880 |
| Water | | 0-100 | 1000 | 4190 |
| Caloriea HT43 | Oil | 12-260 | 867 | 2200 |
| Engine oil | Oil | Up to 160 | 888 | 1880 |
| Ethanol | Organic | Up to 78 | 790 | 2400 |
| | liquid | | | |
| Proponal | Organic | Up to 97 | 800 | 2500 |
| | liquid | | | |
| Butanol | Organic | Up to 118 | 809 | 2400 |
| | liquid | | | |
| Isotunaol | Organic | Up to 100 | 808 | 3000 |
| | liquid | | | |
| Isopentanol | Organic | Up to 148 | 831 | 2200 |
| | liquid | | | |
| Octane | Organic | Up to 126 | 704 | 2400 |
| | liquid | | | |

What is claimed is:

1. A hydrogen generation system, comprising:
a solid hydrogen fuel;
an absorbent material, absorbing a liquid in the system; and
a phase-change material, disposed adjacent to a position at which a hydrogen releasing reaction occurs, the phase-change material absorbing and storing the reaction heat generated from the hydrogen releasing reaction reacted by the solid hydrogen fuel and the liquid, and then maintaining a reaction temperature, thereby controlling a hydrogen releasing rate of the hydrogen releasing reaction and stabilizing a hydrogen flow.

2. The hydrogen generation system according to claim 1, wherein the phase-change material, the solid hydrogen fuel and the absorbent material are disposed in a single pack.

3. The hydrogen generation system according to claim 1, wherein the solid hydrogen fuel and the absorbent material are mixed in a pack, the phase-change material is disposed outside the pack and directly contacts a container for placing the pack.

4. The hydrogen generation system according to claim 1, wherein the absorbent material comprises the liquid of water, alcohols and aqueous solutions thereof, aqueous solutions of salts, or aqueous solutions of acids, and the solid hydrogen fuel at least comprises:
a solid hydride powder, reacted with the liquid to bring about the hydrogen releasing reaction; and
a solid hydrogen releasing catalyst, catalyzing the hydrogen releasing reaction for producing hydrogen.

5. The hydrogen generation system according to claim 4, wherein the solid hydride powder is selected from the group consisting of boron hydride, nitrogen hydride, carbon hydride, metal hydride, nitrogen borohydride, carbon borohydride, nitrogen carbon hydride, metal borohydride, metal nitrogen hydride, metal carbon hydride, metal nitrogen borohydride, metal carbon borohydride, metal nitrogen carbon hydride, nitrogen carbon borohydride, metal nitrogen carbon borohydride, and a combination thereof.

6. The hydrogen generation system according to claim 5, wherein the solid hydride powder is selected from the group consisting of sodium borohydride (NaBH₄), lithium aluminum hydride (LiAlH₄), sodium aluminum hydride (NaAlH₄), magnesium aluminum hydride (Mg(AlH₄)₂), calcium aluminum hydride (Ca(AlH₄)₂), lithium borohydride (LiBH₄), potassium borohydride (KBH₄), beryllium borohydride (Be(BH₄)₂), magnesium borohydride (Mg(BH₄)₂), calcium borohydride (Ca(BH₄)₂), lithium hydride (LiH), sodium hydride (NaH), magnesium hydride (MgH₂) and calcium hydride (CaH₂).

7. The hydrogen generation system according to claim 4, wherein the solid hydride powder is a hydride or a chemical compound represented by the formula BxNyHz.

8. The hydrogen generation system according to claim 4, wherein the solid hydrogen releasing catalyst comprises solid acid, or metal salt comprising at least one of ruthenium, cobalt, nickel, copper and iron, or metal nano-particles/micro-particles comprising at least one of ruthenium, cobalt, nickel, copper and iron, or a plurality of catalyst metal carriers covered by metal irons/metal atomics/metal nano-particles/meta micro-particles comprising at least one of ruthenium, cobalt, nickel, copper and iron.

9. The hydrogen generation system according to claim 4, wherein the solid hydrogen fuel comprises a flexible polymer matrix having a hydrophobic polymer elastomer.

10. The hydrogen generation system according to claim 1, wherein the absorbent material comprises an absorbing cotton, and at least an absorbent polymer comprising at least one or more of polyacrylate, poly(vinyl alcohol), vinyl acetate copolymer, poly urethane, poly(ethylene oxide), and starch graft copolymer/rubber blend.

11. The hydrogen generation system according to claim 1, wherein the phase-change material is selected from the group of compounds as listed in Table 1˜Table 4, consisting of an organic phase-change material, an inorganic phase-change material, and a combination thereof, wherein the organic phase-change material is selected from the group consisting of aliphatic compounds, polyhydric alcohols and paraffin, the inorganic phase-change material is one of acids, or one of hydrated slats with melting points ranged from 15˜120.

12. A method for generating hydrogen using solid hydrogen fuel, comprising:
providing a solid hydrogen fuel, at least comprising a solid hydride powder and a solid hydrogen releasing catalyst;
providing an absorbent material, mixed with the solid hydrogen fuel in a fuel pack;
providing a liquid pack comprising a liquid of water, alcohols and aqueous solutions thereof, aqueous solutions of salts, aqueous solutions of acids, or a combination thereof;
providing a phase-change material, disposed adjacent to the solid hydrogen fuel; and
conducting water or aqueous solution of the liquid pack into the fuel pack for bringing about a hydrogen releasing reaction;
wherein the absorbent material is capable of absorbing the liquid of water, alcohols and aqueous solutions thereof, aqueous solutions of salts, aqueous solutions of acids, or the combination thereof, and the phase-change material is used for stabilizing a temperature of the hydrogen releasing reaction reacted by the solid hydrogen fuel and the liquid.

13. The method for generating hydrogen according to claim 12, wherein the phase-change material, the solid hydrogen fuel and the absorbent material are disposed in the fuel pack.

14. The method for generating hydrogen according to claim 12, wherein the phase-change material is disposed outside the fuel pack and directly contacts a container for placing the fuel pack.

15. The method for generating hydrogen according to claim 12, wherein the solid hydride powder is selected from the group consisting of boron hydride, nitrogen hydride, carbon hydride, metal hydride, nitrogen borohydride, carbon borohydride, nitrogen carbon hydride, metal borohydride, metal nitrogen hydride, metal carbon hydride, metal nitrogen borohydride, metal carbon borohydride, metal nitrogen carbon hydride, nitrogen carbon borohydride, metal nitrogen carbon borohydride, and a combination thereof.

16. The method for generating hydrogen according to claim 15, wherein the solid hydride powder is selected from the group consisting of sodium borohydride (NaBH₄), lithium aluminum hydride (LiAlH₄), sodium aluminum hydride (NaAlH₄), magnesium aluminum hydride (Mg(AlH₄)₂), calcium aluminum hydride (Ca(AlH₄)₂), lithium borohydride (LiBH₄), potassium borohydride (KBH₄), beryllium borohydride (Be(BH₄)₂), magnesium borohydride (Mg(BH₄)₂), calcium borohydride (Ca(BH₄)₂), lithium hydride (LiH), sodium hydride (NaH), magnesium hydride (MgH₂) and calcium hydride (CaH₂).

17. The method for generating hydrogen according to claim 12, wherein the solid hydrogen releasing catalyst comprises solid acid, or metal salt comprising at least one of ruthenium, cobalt, nickel, copper and iron, or metal nano-particles/micro-particles comprising at least one of ruthenium, cobalt, nickel, copper and iron, or a plurality of catalyst metal carriers covered by metal irons/metal atomics/metal nano-particles/meta micro-particles comprising at least one of ruthenium, cobalt, nickel, copper and iron.

18. The method for generating hydrogen according to claim 12, wherein the solid hydrogen fuel comprises a flexible polymer matrix having a hydrophobic polymer elastomer.

19. The method for generating hydrogen according to claim 12, wherein the absorbent material comprises an absorbing cotton, and at least an absorbent polymer comprising at least one or more of polyacrylate, poly(vinyl alcohol), vinyl acetate copolymer, poly urethane, poly(ethylene oxide), and starch graft copolymer/rubber blend.

20. The method for generating hydrogen according to claim 12, wherein the phase-change material is selected from the group of compounds as listed in Table 1˜Table 4, consisting of an organic phase-change material, an inorganic phase-change material, and a combination thereof, wherein the organic phase-change material is selected from the group consisting of aliphatic compounds, polyhydric alcohols and paraffin, the inorganic phase-change material is one of acids, or one of hydrated slats with melting points ranged from 15˜120.

21. A method of applying solid hydrogen fuel to fuel cell, comprising:
providing a solid hydrogen fuel, at least comprising a solid hydride powder and a solid hydrogen releasing catalyst;
providing an absorbent material, mixed with the solid hydrogen fuel in a fuel pack;
providing a liquid pack comprising a liquid of water, alcohols and aqueous solutions thereof, aqueous solutions of salts, aqueous solutions of acids, or a combination thereof;
providing a phase-change material, disposed adjacent to the solid hydrogen fuel;
conducting water or aqueous solution of the liquid pack into the fuel pack for bringing about a hydrogen releasing reaction; and
providing a fuel cell applied with the hydrogen released from the solid hydrogen fuel;
wherein the absorbent material is capable of absorbing the liquid of water, alcohols and aqueous solutions thereof, aqueous solutions of salts, aqueous solutions of acids, or the combination thereof, and the phase-change material is used for stabilizing a temperature of the hydrogen releasing reaction reacted by the solid hydrogen fuel and the liquid.

22. The method of applying solid hydrogen fuel according to claim 21, wherein the phase-change material is disposed outside the fuel pack and directly contacts a container for placing the fuel pack, and also directly contacts a casing of the fuel cell while the solid hydrogen fuel is applied to the fuel cell.
